(19) United States
(12) Patent Application Publication
(10) Pub. No.: US 2026/0285210 A1
(43) Pub. Date: Sep. 24, 2026

(54) BLOWER AND VEHICLE SEAT

(71) Applicant: TOYOTA BOSHOKU KABUSHIKI KAISHA, Aichi (JP)

(72) Inventor: Hiroshi MURAHATA, Miyoshi-shi (JP)

(73) Assignee: TOYOTA BOSHOKU KABUSHIKI KAISHA, Aichi (JP)

(21) Appl. No.: 19/563,298

(22) Filed: Mar. 11, 2026

(30) Foreign Application Priority Data
Mar. 24, 2025 (JP) 2025-048690

(51) Int. Cl. B60N 2/56

(52) U.S. Cl. CPC B60N 2/5642; B60N 2/5657

(57) ABSTRACT

One aspect of the present disclosure provides a blower including an impeller, an electric motor, a circuit board, and a casing. The casing (i) houses the impeller, the electric motor, and the circuit board, and (ii) is configured to be disposed inside a vehicle seat. The casing includes a first end portion and a second end portion opposing each other along a rotation axis of the impeller. The first end portion includes an airflow port for the airflow. The second end portion includes (i) a closed portion and (ii) a drain port for discharging liquid. The drain port is at least partially offset from the circuit board when projected onto an imaginary plane perpendicular to the rotation axis.

### CROSS-REFERENCE TO RELATED APPLICATIONS

This application claims the benefit of Japanese Patent Application No. 2025-048690 filed on March 24, 2025 with the Japan Patent Office, the entire disclosure of which is incorporated herein by reference.

### BACKGROUND

The present disclosure relates to a blower for seat air-conditioning and a vehicle seat.

Japanese Patent No. 6719841 discloses a blower configured to prevent moisture blown off from an impeller from entering a space below the impeller by introducing the moisture into a blowout flow path.

### SUMMARY

The blower described above cannot prevent all moisture from entering the space below the impeller, nor can it discharge moisture that has entered the space.

It is desirable that one aspect of the present disclosure can provide a blower capable of discharging liquid that has entered a space below an impeller.

One aspect of the present disclosure may provide a blower comprising an impeller, an electric motor, a circuit board, and a casing.

The impeller is configured to rotate about a rotation axis to thereby generate an airflow. The electric motor is configured to rotate the impeller. The circuit board is electrically coupled to the electric motor. The casing (i) houses the impeller, the electric motor, and the circuit board, and (ii) is configured to be disposed inside a vehicle seat. The casing includes a first end portion and a second end portion opposing each other along the rotation axis. The first end portion includes an airflow port for the airflow. The second end portion includes (i) a closed portion and (ii) a drain port for discharging liquid. The drain port is at least partially offset from the circuit board when projected onto an imaginary plane perpendicular to the rotation axis.

In such a blower, liquid that has entered the casing can be reliably discharged through the drain port.

In a configuration where the entire drain port overlaps the circuit board when projected onto the imaginary plane and an inner wall of the casing and the circuit board are arranged close to each other, the liquid adheres to the circuit board and the inner wall due to surface tension generated in the liquid, making it difficult to be discharged through the drain port.

If a separation distance between the inner wall and the circuit board is sufficiently large, the influence of the surface tension of the liquid can be reduced. However, the casing, and thus the blower may increase in size.

In the blower described above, since at least a part of the drain port is offset from the circuit board when projected onto the imaginary plane, the influence of the surface tension can be reduced while suppressing an increase in the size of the air blower. Thus, the liquid that has entered the casing can be reliably discharged through the drain port.

The second end portion of the casing may include an inner wall. The inner wall may include an inclined portion having a height from the inner wall that decreases toward the drain port. With such an inclined portion, the liquid that has entered the casing can be more reliably discharged through the drain port.

Alternatively, the inner wall may include first and second reinforcing ribs each (i) having a wall shape and (ii) protruding toward the airflow port. The first reinforcing rib may (i) be closer to the drain port than the second reinforcing rib is, and (ii) have a height from the inner wall lower than a height of the second reinforcing rib from the inner wall.

This may make it possible to discharge the liquid that has entered the casing from the drain port while ensuring the rigidity of the casing.

The circuit board may comprise a control circuit configured to control the electric motor such that the impeller and/or the electric motor rotates at a resonance frequency. The resonance rotation speed (which corresponds to a resonance frequency) may correspond to a rotation speed at which the casing resonates. In this case, by utilizing the resonance of the casing, the liquid in the casing can be more reliably discharged through the drain port.

The control circuit may be configured to control the electric motor such that the impeller and/or the electric motor rotates at the resonance frequency in coordination with vibration of an internal combustion engine of a vehicle. In this case, since the resonance of the casing is masked by the vibration of the internal combustion engine, it is possible to suppress a user from feeling significant discomfort.

The control circuit may be configured to control the electric motor such that the impeller and/or the electric motor rotates at the resonance frequency in response to starting of the internal combustion engine.

Another aspect of the present disclosure may provide a vehicle seat comprising the blower described above.

The vehicle seat may include (i) a seat back configured to support a back of an occupant, and (ii) a seat cushion configured to support buttocks and a thigh of the occupant. The blower may be disposed inside the seat cushion.

### BRIEF DESCRIPTION OF THE DRAWINGS

Example embodiments of the present disclosure will be described hereinafter with reference to the accompanying drawings, in which:

FIG. 1 shows a vehicle sheet according to a first embodiment;

FIG. 2 shows a structural arrangement of a blower in the first embodiment;

FIG. 3 shows the blower in the first embodiment;

FIG. 4 shows a structure of the blower in the first embodiment;

FIG. 5 shows a relationship between a drain port and a circuit board in the first embodiment;

FIG. 6 shows a relationship between the drain port and the circuit board in the first embodiment;

FIG. 7 is a block diagram showing a drive system of the blower according to the first embodiment;

FIG. 8 is a flowchart of a resonance control;

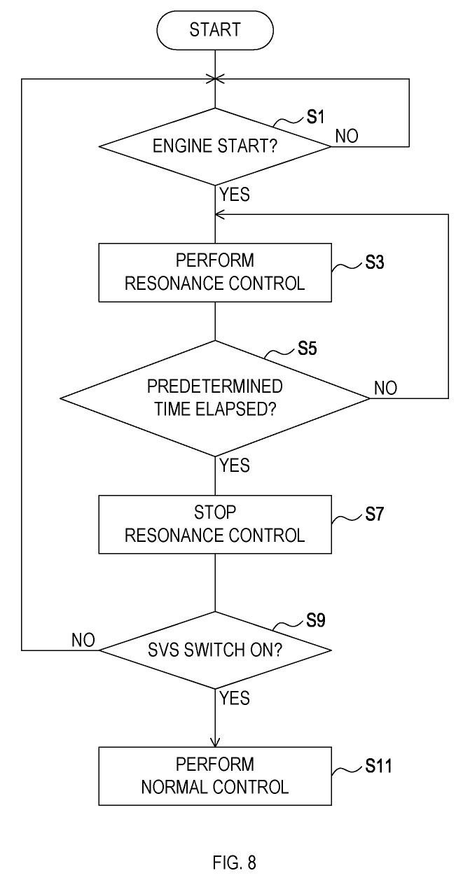

FIG. 9 shows a blower in a second embodiment;

FIG. 10 shows the blower in the second embodiment;

FIG. 11 shows a structure of a casing according to a third embodiment; and

FIG. 12 shows a structure of the casing according to the third embodiment.

### DETAILED DESCRIPTION OF EXEMPLARY EMBODIMENTS

The following embodiments show examples of embodiments that fall within the technical scope of the present disclosure. In other words, the present disclosure is not limited to the specific configurations, structures, or the like described in the following embodiments.

The following embodiments are non-limiting examples where a blower according to the present disclosure is applied to a seat to be mounted to a vehicle such as an automobile (hereinafter referred to as a “vehicle seat”). Arrows indicating directions and hatching in each drawing are provided to facilitate understanding of relationships between the drawings and shapes of members or portions, or the like.

Accordingly, the orientation of the blower is not limited to the directions indicated in the drawings. The directions shown in the drawings correspond to directions in a state where the vehicle seat according to the following embodiments is assembled to a vehicle. Drawings with hatching do not always indicate cross-sectional views.

At least one of each member or portion described with a reference numeral is provided, unless otherwise specifically described as being “only one”. In other words, two or more of such a member or portion may be provided unless it is described as being “only one.” The blower according to the present disclosure includes at least one of elements such as members or portions described with reference numerals, and structural components shown in the drawings.

### 1. First Embodiment

### 1-1. Outline of Vehicle Seat

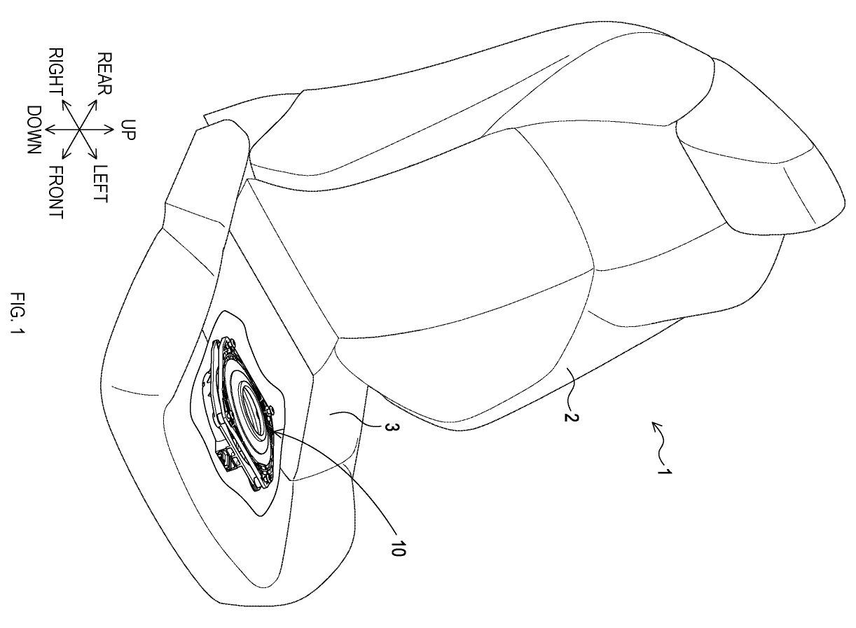

FIG. 1 shows a vehicle seat 1 according to the present embodiment.

The vehicle seat 1 comprises at least a seatback 2 and a seat cushion 3. The seatback 2 is configured to support the back of an occupant. The seat cushion 3 is configured to support buttocks, thighs, and the like of the occupant. In the present embodiment, the vehicle seat 1 comprises a blower 10 inside the seat cushion 3. The blower 10 is configured to generate an airflow for seat air conditioning (or seat ventilation).

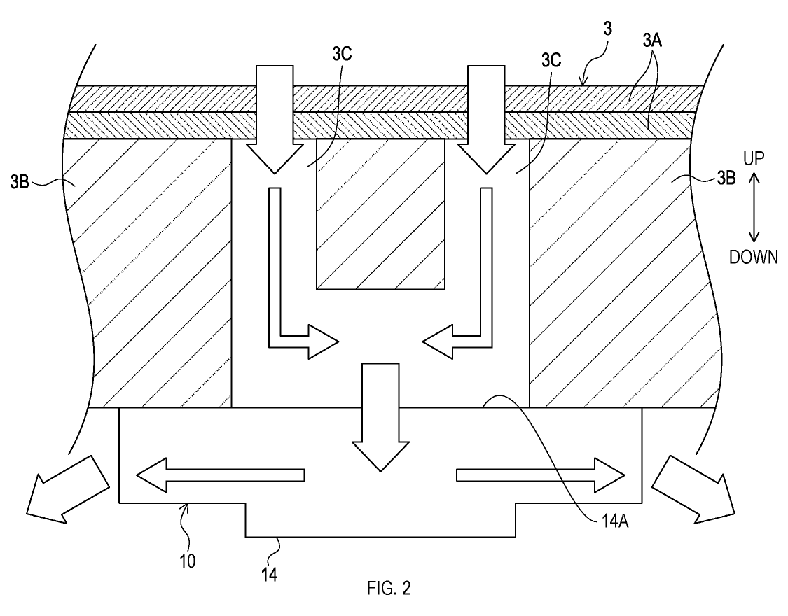

As shown in FIG. 2, the seat cushion 3 includes (i) a double-layered skin 3A having air permeability, and (ii) a cushion pad 3B on an inner side of the double-layered skin 3A. An airflow passage 3C is provided in the cushion pad 3B.

The blower 10 according to the present embodiment is arranged below the cushion pad 3B so as to draw in air from the thighs of the occupant, that is, from the double-layered skin 3A through the airflow passage 3C, and blow the drawn-in air into the seat cushion 3.

### 1-2. Structure of Blower

### 1-2-1. Outline of Blower

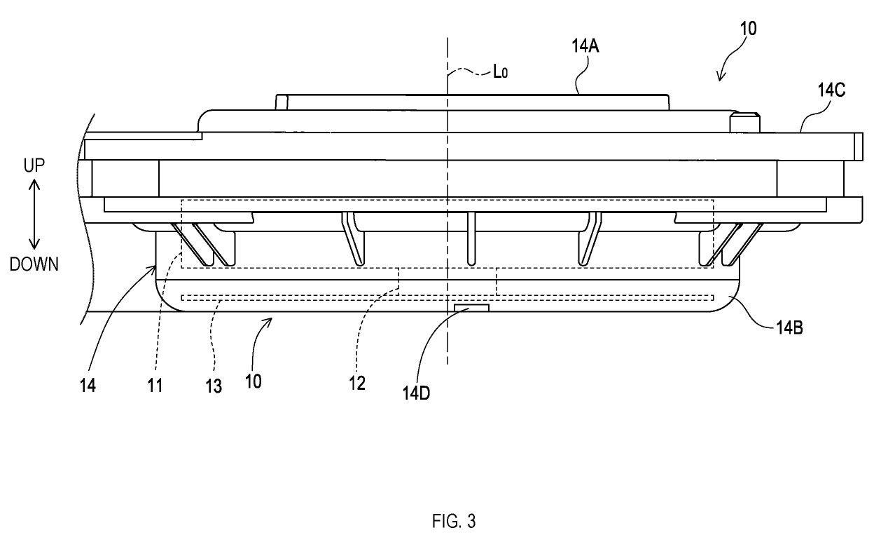

As shown in FIG. 3, the blower 10 includes at least an impeller 11, an electric motor 12, a circuit board 13, and a casing 14.

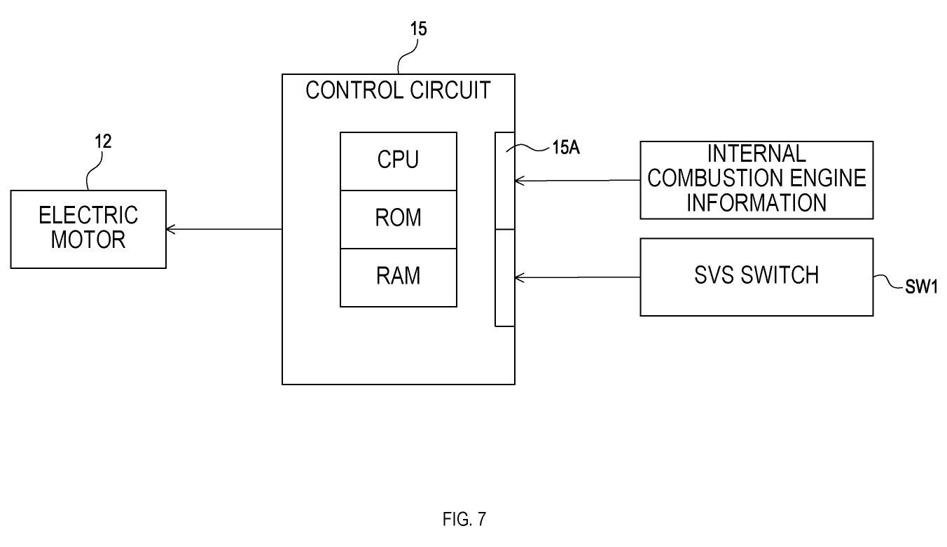

The impeller 11 is configured to rotate about a rotation axis Lo to thereby generate an airflow. The impeller 11 is a centrifugal impeller, for example. The electric motor 12 is configured to generate torque for rotating the impeller 11. The circuit board 13 is electrically coupled to the electric motor 12. Mounted on the circuit board 13 are a drive circuit (not illustrated) for driving the electric motor 12, a controller 15 (see FIG. 7) for controlling the drive circuit (and thus the electric motor 12), and the like. The casing 14 houses the impeller 11, the electric motor 12, and the circuit board 13.

As shown in FIG. 2, the casing 14 is provided with an airflow port 14A for the airflow. Specifically, air drawn into the blower 10 from the double-layered skin 3A is drawn into the impeller 11 through the airflow port 14A (hereinafter also referred to as air-drawing inlet 14A).

As shown in FIG. 3 the casing 14 includes a first end portion and a second end portion opposing each other along the rotation axis Lo. The first end portion includes the air-drawing inlet 14A. In the present embodiment, the rotation axis Lo approximately coincides with an up-down directions. Therefore, the first end portion corresponds to an upper end portion of the casing 14, and the second end portion corresponds to a lower end portion of the casing 14. That is, the air-drawing inlet 14A is disposed on the upper end portion of the casing 14.

### 1-2-2. Detailed Structure of Casing

Continuing to refer to FIG. 3, the casing 14 according to the present embodiment includes a first casing 14B and a second casing 14C. The electric motor 12 and the circuit board 13 are fixed in the first casing 14B.

The second casing 14C includes the air-drawing inlet 14A. Thus, the first casing 14B according to the present embodiment is located below the second casing 14C. The impeller 11 is disposed in a space surrounded by the first casing 14B and the second casing 14C.

The lower end of the casing 14 includes (i) a closed portion and (ii) at least two drain ports 14D. FIG. 3 shows only one of these drain ports 14D. Each drain port 14D is configured to discharge liquid, such as water, that has entered the casing 14.

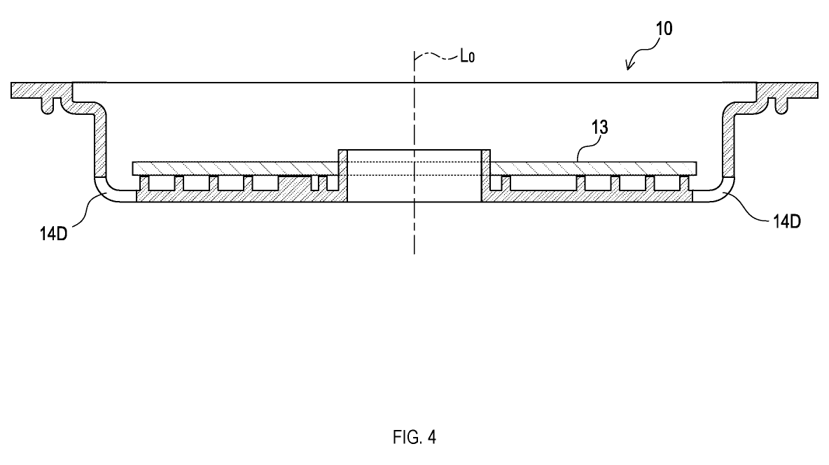

As shown in FIG. 4, when projected onto an imaginary plane perpendicular to the rotation axis Lo (that is, a plane perpendicular to the paper surface of FIG. 4), at least a part of each drain port 14D is offset from the circuit board 13.

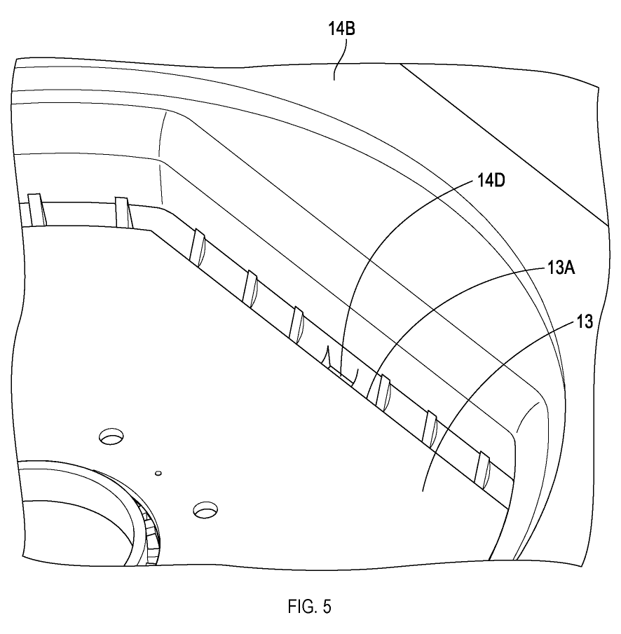

Specifically, as shown in FIG. 5, in the present embodiment, a part of each drain port 14D is offset from a corresponding edge 13A of the circuit board 13. In other words, when an observer views the circuit board 13 along the rotation axis Lo from the first end portion, the observer can visually recognize a part of an inner edge of each drain port 14D.

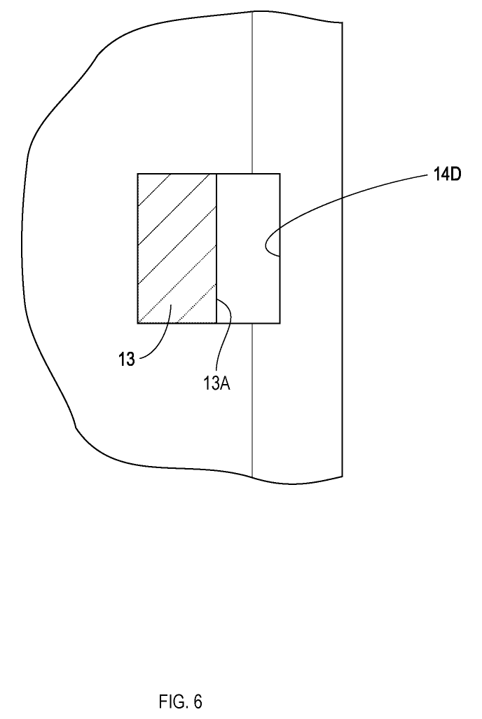

As shown in FIG. 6, when the observer observes each drain port 14D from the lower end of the first casing 14B, the observer can see a part of the corresponding edge 13A of the circuit board 13 through each drain port 14D.

### 1-3. Control of Electric Motor

### 1-3-1. Overview of Control of Electric Motor

As shown in FIG. 7, the driving of the electric motor 12 is controlled by the control circuit 15 via a drive circuit (not shown). In the present embodiment, the control circuit 15 is a microcontroller having a CPU, RAM, ROM, and the like, but is not limited thereto.

The controller 15 is configured to perform normal control and resonance control. The normal control is performed when a seat ventilation system (SVS) switch SW1 is manually turned on by a user. In the normal control, the control circuit 15 rotates the impeller 11 and the electric motor 12 at a predetermined rotation speed (hereinafter referred to as a normal rotation speed).

In the resonance control, the control circuit 15 drives the impeller 11 and the electric motor 12 at a predetermined resonance rotation speed (which corresponds to a predetermined resonance frequency) when a predetermined timing is reached. The resonance rotation speed corresponds to a rotation speed at which the casing 14 resonates. More specifically, the resonance rotation speed corresponds to, for example, a natural frequency of the blower 10. The predetermined timing is an arbitrary timing including when the internal combustion engine is started or when the internal combustion engine is stopped. The control circuit 15 according to the present embodiment performs the resonance control when the internal combustion engine is started. The control circuit 15 includes an input port 15A configured to receive a signal indicating the start of the internal combustion engine.

The normal rotation speed is a sufficiently high rotation speed compared to the resonance rotation speed. That is, during the normal control, the casing 14 does not resonate in principle.

### 1-3-2. Details of Motor Control

Control of the electric motor (hereinafter referred to as motor control) according to the present embodiment is automatically performed during operation of the control circuit 15. When the motor control is started, the control circuit 15 determines whether a starting operation of the internal combustion engine is being performed (S1).

Examples of the starting operation includes a manual operation by a driver and an automatic operation by an engine electronic control unit (EECU) as in a hybrid vehicle or the like.

If the control circuit 15 determines that the starting operation is being performed (S1: YES), the control circuit 15 performs the resonance control (S3). The control circuit 15 then determines whether a predetermined time (for example, five seconds) has elapsed since the start of performance of the resonance control (S5).

When the predetermined time has elapsed since the start of performance of the resonance control (S5: YES), the control circuit 15 stops the resonance control (S7). Before the predetermined time elapses after the start of performance of the resonance control (S5: NO), the resonance control is continuously performed.

The control circuit 15 then determines whether the SVS switch SW1 is turned on (S9). If the SVS switch SW1 is not turned on (S9: NO), the control circuit 15 performs S1 again.

If the SVS switch SW1 is turned on (S9: YES), the control circuit 15 performs the normal control (S11). Thereafter, the control circuit 15 stops the normal control in response to the SVS switch SW1 being turned off.

### 1-4. Features of Blower According to Present Embodiment

In the blower 10 according to the present embodiment, at least a part of each drain port 14D is offset from the circuit board 13 when projected onto the imaginary plane perpendicular to the rotation axis Lo (see FIG. 5).

Accordingly, in the blower 10, liquid that has entered the casing 14 can be reliably discharged through at least any one of the drain ports 14D. If the entire of each drain port 14D overlapped with the circuit board 13 when projected onto the imaginary plane, and the inner wall of the casing 14 and the circuit board 13 were arranged close to each other, the liquid would adhere to the circuit board 13 and the inner wall due to surface tension generated in the liquid, making it difficult for the liquid to be discharged through any of the drain ports 14D.

In this respect, if the separation distance between the inner wall and the electric board 13 is sufficiently large, the influence of surface tension can be reduced. However, if the separation distance is sufficiently large, it results in an increase in the size of the casing 14 and therefore the blower 10.

However, in the blower 10 according to the present embodiment, since at least a part of each drain port 14D is offset from the circuit board 13 when projected onto the imaginary plane, the blower 10 can exhibit an effect equivalent to that of a large blower having a sufficiently large separation distance without increasing the separation distance.

Therefore, in the blower 10, an increase in the size of the blower 10 is suppressed, and liquid that has entered the casing 14 can be reliably discharged through at least any one of the drain ports 14D.

In the present embodiment, the control circuit 15 performs the resonance control when the predetermined timing is reached. When the resonance control is performed, the casing 14 vibrates, which facilitates the liquid that adheres to the inner wall of the casing 14 to flow to at least any one of the drain ports 14D. Accordingly, in the blower 10, it may be possible to reliably discharge the liquid that has entered the casing 14 through at least any one of the drain ports 14D.

Furthermore, in the present embodiment, since the resonance control is performed in response to the start of the internal combustion engine, the resonance of the casing 14 is masked by the vibration of the internal combustion engine, and it is possible to suppress the user from feeling considerable discomfort.

### 2.Second Embodiment

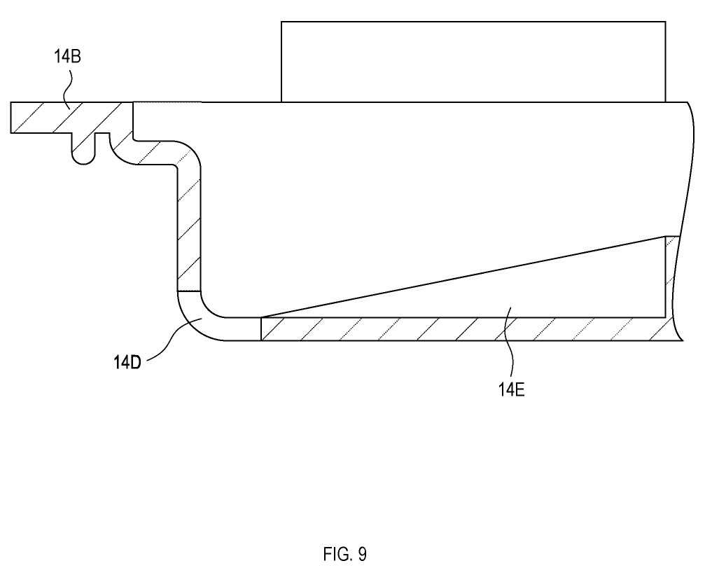

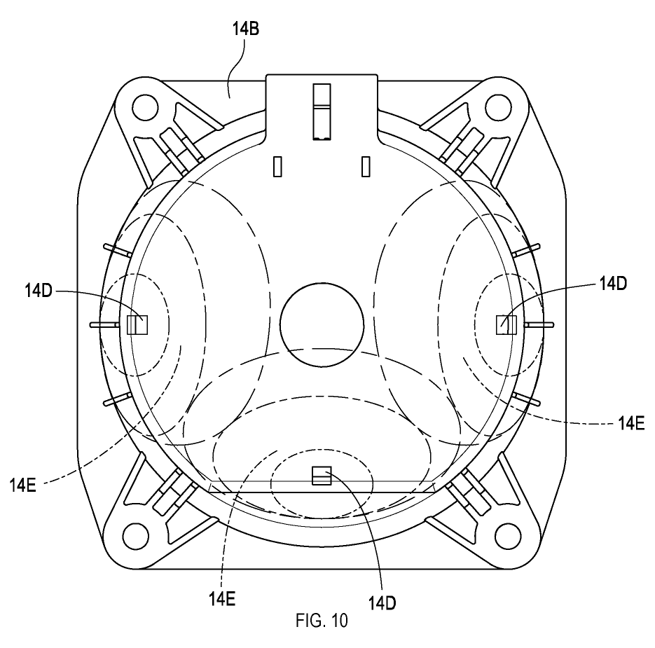

In the present embodiment, as shown in FIG. 9, inclined portions 14E corresponding to the respective drain ports 14D are provided on the inner wall of the second end portion (the lower end portion in the present embodiment) of the casing 14. Each inclined portion 14E is configured such that its height from the inner wall decreases toward the corresponding drain port 14D. In the present embodiment, as shown in FIG. 10, three drain ports 14D are provided, and three inclined portions 14E are provided.

In the present embodiment, this allows a reliable discharge of liquid that has entered the casing 14 through at least any one of the drain ports 14D. Elements identical to those in the aforementioned first embodiment are denoted by the same reference numerals as those in the first embodiment. Thus, in the present embodiment, descriptions that are the same as those described in the first embodiment are omitted.

### 3. Third Embodiment

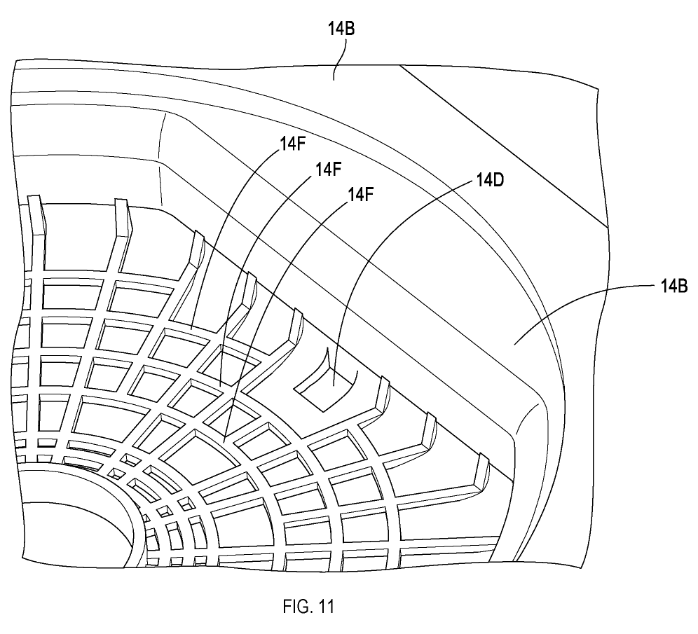

As shown in FIG. 11, the first casing 14B according to the present embodiment is provided with reinforcing ribs 14F forming reinforcing ridges. These reinforcing ribs 14F are annular ridges centered on the rotation axis Lo, and are formed in a wall shape protruding toward the air-drawing inlet 14A.

Thus, in the present embodiment, when liquid that has flowed into the casing 14 flows toward at least any one of the drain ports 14D, these reinforcing ribs 14F may function as “dam” and obstruct the flow.

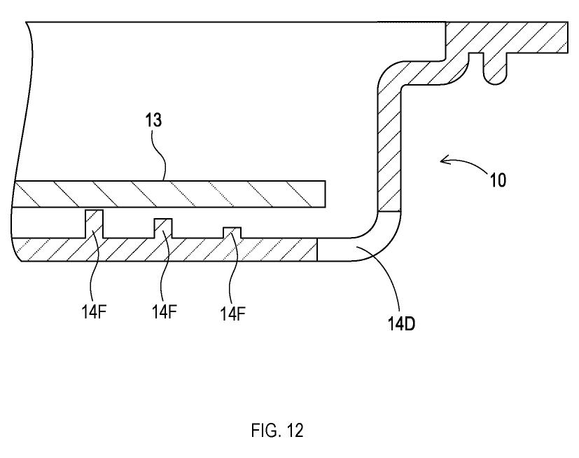

As shown in FIG. 12, in the present embodiment, a reinforcing rib 14F at a position close to a corresponding drain port 14D is lower in height than another reinforcing rib 14F at a position away from the corresponding drain port 14D.

In other words, in the present embodiment, the reinforcing ribs 14F are configured such that their height decreases toward the corresponding drain port 14D. The height of the reinforcing rib 14F corresponds to a dimension from the inner wall surface of the casing 14 to an upper end of the reinforcing rib 14F.

This ensures the rigidity of the casing 14 and allows liquid that has entered the casing 14 to be discharged through at least any one of the drain ports 14D in the present embodiment.

Elements identical to those in the aforementioned first and second embodiments are denoted by the same reference numerals as those in the first and second embodiments. Thus, in the present embodiment, descriptions that are the same as those described in the first and second embodiments are omitted.

### 4. Other Embodiments

In the first through third embodiments, the present disclosure has been described as being applied to a vehicle including an internal combustion engine as a drive power source. However, the present disclosure is not limited thereto. For example, the present disclosure is also applicable to a vehicle including only an electric motor as a drive power source (e.g., an electric vehicle (EV)).

In the second embodiment, the three inclined portions 14E are provided in the casing 14. However, the present disclosure is not limited thereto. For example, one or more inclined portions 14E may be omitted.

In the third embodiment, the reinforcing ribs 14F are provided in the casing 14. However, the present disclosure is not limited thereto. For example, the reinforcing ribs 14F may be omitted.

In the first through third embodiments, the blower 10 has been described as being configured to perform the resonance control. However, the present disclosure is not limited thereto. For example, the blower 10 may be configured not to perform the resonance control.

In the first though third embodiments, the resonance control has been described as being performed upon starting or stopping the internal combustion engine. However, the present disclosure is not limited thereto. For example, the resonance control may be performed at other timings (e.g., periodically).

In the first through third embodiments, the blower 10 has been described as being disposed inside the seat cushion 3. However, the present disclosure is not limited thereto. For example, the blower 10 may be disposed inside the seatback 2.

In the first through third embodiments, at least a part of each drain port 14D has been described as being offset from the circuit board 13 when projected onto the imaginary plane. However, the present disclosure is not limited thereto. For example, each drain port 14D may entirely overlap with the circuit board 13.

In the first through third embodiments, at least a part of each drain port 14D has been described as being offset from the corresponding edge 13A of the circuit board 13. However, the present disclosure is not limited thereto. For example, a through-hole may be provided in a portion of the circuit board 13 facing each drain port 14D. In such a configuration, at least a part of each drain port 14D is visible through the through-hole when the circuit board 13 is viewed from the upper end portion of the casing 14.

In the first through third embodiments, the vehicle seat according to the present disclosure has been described as being applied to an automobile. However, the present disclosure is not limited thereto. The present disclosure is also applicable to seats used in various vehicles such as railroad vehicles, watercraft (e.g., ships and boats), and aircraft, and also to stationary seats used in theaters and households, for example.

Furthermore, the present disclosure is not limited to the above-described embodiments as long as it conforms to the spirit of the disclosure described in the above-described embodiments. Therefore, a configuration in which at least two of the embodiments described above are combined, or a configuration in which any of the components illustrated or described with reference numerals in the above-described embodiments is omitted, may be employed.

What is claimed is:

1. A blower comprising:
an impeller configured to rotate about a rotation axis to thereby generate an airflow;
an electric motor configured to rotate the impeller;
a circuit board electrically coupled to the electric motor; and
a casing (i) housing the impeller, the electric motor, and the circuit board, and (ii) configured to be disposed inside a vehicle seat, the casing including a first end portion and a second end portion opposing each other along the rotation axis, the first end portion including an airflow port for the airflow, the second end portion including (i) a closed portion and (ii) a drain port for discharging liquid, the drain port being at least partially offset from the circuit board when projected onto an imaginary plane perpendicular to the rotation axis.

2. The blower according to claim 1, wherein:
the second end portion of the casing includes an inner wall; and
the inner wall includes an inclined portion having a height from the inner wall that decreases toward the drain port.

3. The blower according to claim 1, wherein:
the second end potion of the casing includes an inner wall;
the inner wall includes first and second reinforcing ribs each (i) having a wall shape and (ii) protruding toward the airflow port; and
the first reinforcing rib (i) is closer to the drain port than the second reinforcing rib is, and (ii) has a height from the inner wall lower than a height of the second reinforcing rib from the inner wall.

4. The blower according to claim 1, wherein:
the circuit board comprises a control circuit configured to control the electric motor such that the impeller and/or the electric motor rotates at a resonance frequency; and
the resonance frequency corresponds to a rotation speed at which the casing resonates.

5. The blower according to claim 4,
wherein the control circuit is configured to control the electric motor such that the impeller and/or the electric motor rotates at the resonance frequency in coordination with vibration of an internal combustion engine of a vehicle.

6. The blower according to claim 5,
wherein the control circuit is configured to control the electric motor such that the impeller and/or the electric motor rotates at the resonance frequency in response to starting of the internal combustion engine.

7. A vehicle seat comprising the blower according to claim 1.

8. The vehicle seat according to claim 7, comprising:
a seat back configured to support a back of an occupant; and
a seat cushion configured to support buttocks and a thigh of the occupant,
wherein the blower is disposed inside the seat cushion.
